(19) United States
(12) Patent Application Publication
(10) Pub. No.: US 2007/0289826 A1
(43) Pub. Date: Dec. 20, 2007

(54) Brake Drum

(76) Inventors: Danet Suryatama, West Bloomfield, MI (US); Robert P. Uhlig, Rochester Hills, MI (US); Robert M. Lundgren, Northville, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/424,398

(22) Filed: Jun. 15, 2006

(51) Int. Cl. F16D 65/10

(52) U.S. Cl. 188/218 R

(57) ABSTRACT

A brake drum includes a generally cylindrical sidewall that defines at least part of a rub track, and a labyrinth that is generally open at one end and leads to a radially inwardly extending endwall at its other end. The labyrinth portion of the sidewall is preferably thicker than the rub track section. Also, in one presently preferred implementation, a transition between the sidewall and the radially inwardly extending face is thicker than the face and preferably has at least one that is portioned at least as thick as the rub track section. The brake drum may have a comparatively increased stiffness, which may reduce deflections or radially runout caused by eccentricity in the shape of the sidewall and resultant uneven friction and temperature loads in use.

### FIELD OF THE INVENTION

This invention relates generally to vehicle braking systems and more particularly to brake drums.

### BACKGROUND OF THE INVENTION

Various braking systems are known and used for stopping vehicles of all types. Among these, disk brakes and drum brakes have been used for many years in automotive vehicles. While disk brakes may be considered an improvement over at least some drum brake designs, drum brakes remain in use in certain automotive vehicles because they are relatively inexpensive and facilitate incorporation of a parking brake to the braking system. Drum brakes utilize a drum that is mounted to and rotates with a vehicle wheel, and one or more shoes that are selectively urged into engagement with the brake drum to slow the rotation of the wheel and stop the vehicle.

### SUMMARY OF THE INVENTION

A brake drum includes a generally cylindrical sidewall that defines at least part of a rub track, and a labyrinth that is generally open at one end and leads to a radially inwardly extending endwall at its other end. The labyrinth portion of the sidewall is preferably thicker than the rub track section. Also, in one presently preferred implementation, a transition between the sidewall and the radially inwardly extending endwall is thicker than the endwall and preferably has at least a portion that is at least as thick as the rub track section.

The brake drum may have a comparatively increased strength or stiffness, which helps reduce deflections or radial runout caused by, for example, eccentricity in the shape of the sidewall and resultant uneven friction and temperature loads in use. In one implementation, the labyrinth section includes a thick inner labyrinth and a relatively thin outer labyrinth which extends and is disposed radially outwardly from the inner labyrinth and the rub track. The labyrinth sections may provide a tortuous path for dirt, water and other contaminants to shield the brake drum and brake shoe interface from such contaminants.

### BRIEF DESCRIPTION OF THE DRAWINGS

These and other objects, features and advantages of the present invention will be apparent from the following detailed description of the preferred embodiments and best mode, appended claims and accompanying drawings in which:

FIG. 1 is a perspective view of one embodiment of a brake drum;

FIG. 2 is another perspective view of the brake drum of FIG. 1; and

FIG. 3 is a cross sectional view of a modified brake drum.

### DETAILED DESCRIPTION OF PREFERRED EMBODIMENTS

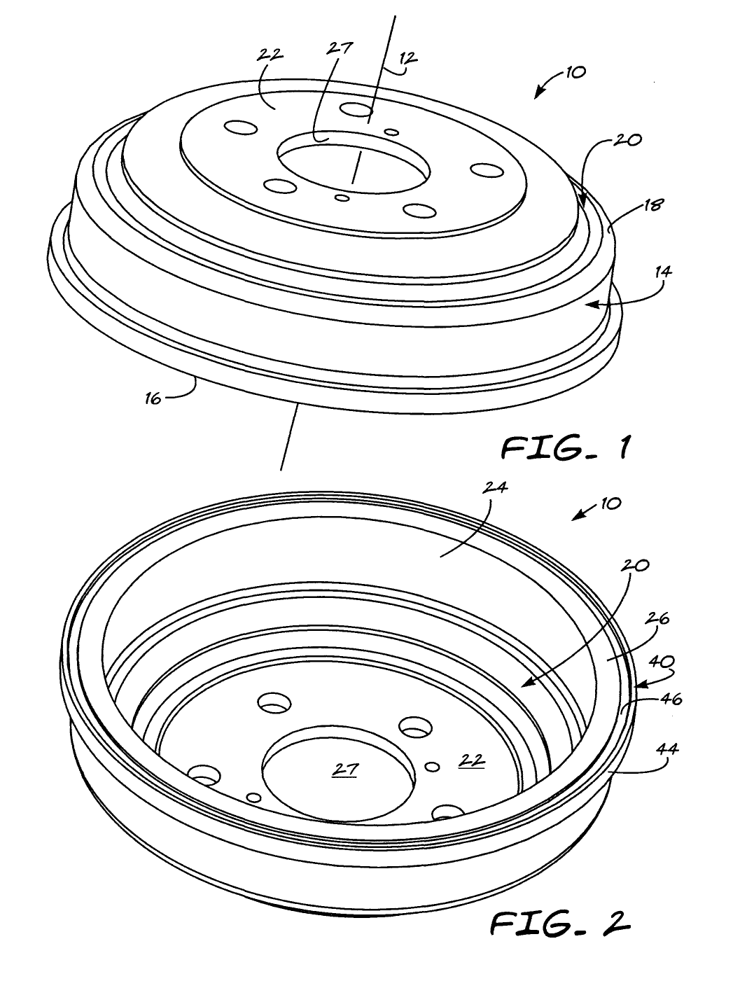

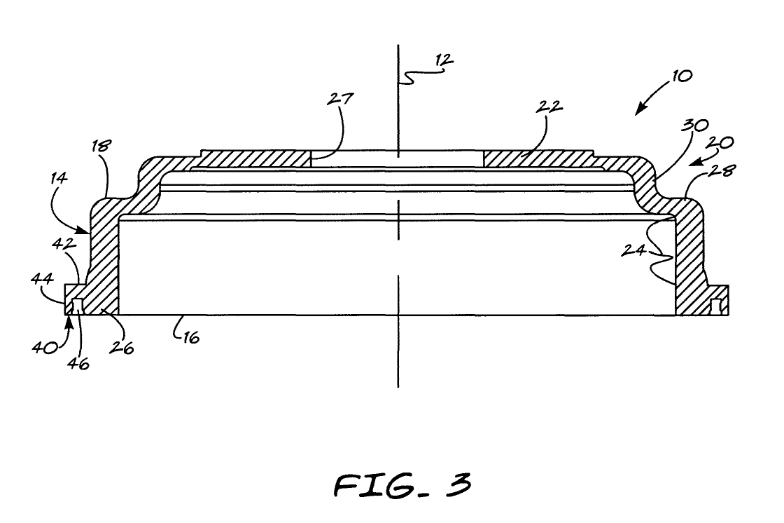

Referring in more detail to the drawings, FIGS. 1-3 illustrate a brake drum 10 for a vehicle brake assembly. The brake drum 10 rotates about an axis 12 and may be used in a conventional brake system wherein a pressurized fluid drives a piston (not shown) that actuates one or more brake shoes (not shown) that engage and frictionally resist rotation of the brake drum 10 to slow the rotation and, if desired, stop the rotation of a wheel to which the brake drum is attached.

The brake drum 10 preferably includes an annular and generally axially extending sidewall 14 open at a first end 16 and leading at its second end 18 to a transition section 20, which in turn leads to a radially inwardly extending endwall 22. The endwall 22 preferably includes a central through opening 27 and may have a generally stepped or contoured profile in cross section for receipt of adjacent components of the braking system, or for other reasons. The endwall 22 may have a smaller diameter than the sidewall 14 and is interconnected to the sidewall 12 by the transition portion 20. The transition section 20 may be generally arcuate and concave, and, as best shown in the brake drum of FIG. 3, may be devoid of any sharp corners. The relatively smooth curves and lack of sharp corners in the transition section 20 may help reduce non-uniform radial runout in the rub track region 24 in use. The transition section 20 includes a first or radially inwardly extending portion 30 extending from the sidewall 14, and a second or generally axially extending portion 28 leading to the endwall 22. The sidewall 14 may include a rub track region 24, and a radially inward or first labyrinth portion 26. The rub track region 24 may be thicker than the endwall 22, and in one implementation the rub track 24 is about 1.2 to 6 times thicker than the endwall 22. The first labyrinth portion 26 is preferably at least as thick, and more preferably is thicker than, the rub track region 24 of the sidewall 14. The first labyrinth portion 26 may be between about 1.1 to 4 times thicker than the rub track region 24.

At least a major portion of the transition section 20 may be thicker in cross section than the endwall 22. Also preferably, a major portion of the transition section 20 is at least 20 percent thicker than the endwall 22, and may be twice or more as thick as the endwall 22. A major portion of the transition section 20 consists, for purposes of this disclosure, as at least one-half of the arcuate distance between the endwall 22 and the sidewall 12. Preferably, the first portion 28 of the transition section 20 is as thick, or nearly so, as the rub track region 24 of the sidewall 14. In one presently preferred implementation, the first portion 28 of the transition section 20 is about 0.7 to 1.5 times as thick as the rub track region 24 of the sidewall 14.

In one presently preferred implementation, the brake drum 10 includes a radially outwardly extending second or outer labyrinth portion 40. The outer labyrinth portion 40 extends axially along a portion of the sidewall 14 and includes a radially outwardly extending section 42 and an axially extending section 44 defining a cavity or circumferential groove 46 that is open at one end and is defined between the first and second labyrinth portions 26, 40. The axially extending section 44 of the second labyrinth 40 is preferably thinner than the first labyrinth 26. The first labyrinth 26 preferably is about 1.05 to 10 times thicker than the second labyrinth 40, more preferably between 1.5 and 3 times thicker than the second labyrinth.

The brake drum 10 may be formed in one unitary piece such as by casting an appropriate metal. Desirably, each portion of the brake drum 10 is concentric about the axis of rotation 12 of the brake drum 10. However, at least some brake drums will be manufactured with some eccentricity. In other words, they will not be perfectly round or coaxially arranged, and they may not be perfectly centered when mounted and assembled on the wheel with which they rotate. Further, components that interact with the brake drum 10, such as the brake shoes, may not be perfectly aligned with the brake drum 10 nor evenly frictionally applied thereto.

Accordingly, the friction force and torque applied to the brake drum 10 may vary as the brake drum rotates. This leads to non-uniform forces on the brake drum and its related components, and non-uniform heat loads applied to the brake drum. This, in turn, will lead to non-uniform distortion of the brake drum 10 wherein certain regions of the brake drum 10 will distort more than others, which can further exacerbate the problem of uneven force and temperature loading on the brake drum.

In one presently preferred implementation, the brake drum 10 is thickest at the locations spaced furthest from the endwall 22 which is mounted to the vehicle wheel. Accordingly, the area furthest from the support or point of connection, which includes the first and second labyrinth portions 26, 40, is stiffest and may be better able to resist distortion in use. With less distortion, there may be less non-uniform force and temperature loading on that area of the brake drum which will tend to reduce or limit subsequent distortion from such uneven performance characteristics. Still further, the rub track region 24 preferably is thicker than the endwall 22 and hence, is stiffer and may be better able to resist distortion caused by eccentricity or uneven loading and temperature characteristics in use. Accordingly, the stiffer rub track region 24 helps to limit the magnitude of the uneven torque and/or temperature loading thereon. This helps to limit the time or temperature based increase of such distortions and may improve performance of the brake drum 10 in use. Still further, the thicker transition section 20 may also provide a stiffer or stronger brake drum 10 that resists distortion due to non-uniform loading and may also facilitate dissipation of heat generated in use of the brake drum.

While certain preferred embodiments have been shown and described, persons of ordinary skill in this art will readily recognize that the preceding description has been set forth in terms of description rather than limitation, and that various modifications and substitutions can be made without departing from the spirit and scope of the invention. The invention is defined by the following claims

What is claimed is:

1. A brake drum, comprising:
an endwall adapted to be connected to a vehicle wheel for rotation about an axis; and
a sidewall extending generally axially from the endwall to an open end wherein the sidewall is thicker in cross section adjacent to the open end than adjacent to the endwall.

2. The brake drum of claim 1 wherein the sidewall includes a rub track section and defines at least a portion of a labyrinth section adjacent to the open end, the labyrinth section having a portion that is thicker in cross section than the rub track section of the sidewall.

3. The brake drum of claim 2 wherein the labyrinth section includes a first labyrinth portion extending from the sidewall and a second labyrinth portion connected to the sidewall and having a portion disposed radially outwardly from the first labyrinth wherein the first labyrinth is thicker in cross section than the second labyrinth.

4. The brake drum of claim 1 which also includes a transition region extending between the sidewall and the endwall, wherein a major portion of the transition region is thicker in cross section than the endwall.

5. The brake drum of claim 4 wherein the major portion of the transition region is at least 20 percent thicker than the endwall.

6. The brake drum of claim 4 wherein the sidewall includes a rub track section and the transition region includes a first portion that is 0.7 to 1.5 times as thick as the rub track section of the sidewall.

7. The brake drum of claim 2 wherein the rub track section is thicker in cross section than the endwall.

8. The brake drum of claim 7 wherein the rub track section is between 1.2 to 6 times thicker than the endwall.

9. The brake drum of claim 3 wherein the first labyrinth portion is between 1.05 to 10 times thicker than the second labyrinth.

10. The brake drum of claim 9 wherein the first labyrinth portion is between 1.5 to 3 times thicker than the second labyrinth.

11. The brake drum of claim 1 wherein the sidewall is thickest adjacent to the open end.

12. A brake drum, comprising:
an endwall adapted to be connected to a wheel for rotation with the wheel about an axis, an annular sidewall carried by the endwall extending axially away from the endwall to an open end, and a generally arcuate transition portion extending between and interconnecting the endwall and the sidewall, the sidewall being thicker adjacent to the open end than adjacent to the endwall and a major portion of the transition region is thicker in cross section than the endwall.

13. The brake drum of claim 12 wherein the sidewall includes a rub track section and defines at least a portion of a labyrinth section adjacent to the open end, the labyrinth section having a portion that is thicker in cross section than the rub track section of the sidewall.

14. The brake drum of claim 13 wherein the labyrinth section includes a first labyrinth portion extending from the sidewall and a second labyrinth portion connected to the sidewall and having a portion disposed radially outwardly from the first labyrinth wherein the first labyrinth is thicker in cross section than the second labyrinth.

15. The brake drum of claim 13 wherein the rub track section is thicker in cross section than the endwall.

16. The brake drum of claim 15 wherein the rub track section is between 1.2 to 6 times thicker than the endwall.

17. The brake drum of claim 12 wherein the major portion of the transition region is at least 20 percent thicker than the endwall.

18. The brake drum of claim 12 wherein the sidewall is thickest adjacent to the open end.

19. The brake drum of claim 12 wherein the transition portion is devoid of any sharp corners.
